(19) United States
(12) Patent Application Publication
(10) Pub. No.: US 2009/0228567 A1
(43) Pub. Date: Sep. 10, 2009

(54) Digital media content promotion methods including automatic alerts

(76) Inventor: Jill Lewis Maurer, Raleigh, NC (US)

Correspondence Address: TRIANGLE PATENTS, P.L.L.C., P.O. BOX 28539, RALEIGH, NC, 27611-8539, US

(21) Appl. No.: 12/075,200

(22) Filed: Mar. 10, 2008

(51) Int. Cl. G06F 15/16

(52) U.S. Cl. 709/207

(57) ABSTRACT

A system and methods for automatic geographic alerts to authorized users, including geography-specific promotional material associated with digital media provided through a website for providing distribution and promotion for the digital content through network-based access to authorized users who pay for predetermined rights.

### BACKGROUND OF THE INVENTION

1. Field of the Invention

The present invention relates generally to digital media content creation and distribution. Further, the present invention relates to digital media creation, upload, download, and rights acquisition by users of a network-based system and methods of using the same.

2. Description of the Prior Art

Historically, music and entertainment was provided solely in a live format, wherein the audience only had real-time, live access to the performance. If someone wanted to access the music and entertainment, one had to travel to be in person for the performance. If payment was required, it would be on a pay-per-attendance basis made at the time the performance was rendered. Still music, plays, readings and other performances were documented on paper and issues of copyright infringement or plagiarism were relevant and problematic, in particular being difficult to monitor and police. Early and distributed release of the documented music by the actual or true author was one possible solution to these problems, although far from completely addressing the issues.

Later, music companies or record labels were established to manage the release and distribution of music and other entertainment. Publishing companies were similarly situated to manage written works, including texts, art, and the like. While distribution of the music and entertainment improved, the selection and timing of release was made by the third party companies, rather than by the artist or the consumer. So many talented artists and authors created works that were still nearly impossible to distribute or promote, in particular beyond time and geographic constraints. Recording and producing the music and entertainment, including digital mastering, was essentially controlled and managed by a few companies, rather than the artists and authors. Artists are paid very small fees, usually less than 10% of revenue from sales. Most of the ownership rights or copyrights were required to be assigned to the companies rather than being retained by the authors in exchange for the selective distribution, which frequently resulted in artistic compromise or censorship.

Compensation is required for the creating and distributing parties within the entertainment equation, otherwise, new content of quality will not be regularly created. While some Internet websites like iTunes at www.apple.com/itunes provide for on-demand download to users having accounts who pay for rights to download copies, these sites do not provide for the user to play or download to a multiplicity of devices, with the exception of backup copies. Users can selectively access content they want, buying on a per-song or per-album basis, and similarly on a per-book or per-movie basis. While this scenario and business model improves distribution and helps to avoid some of the illegal downloading by making access to content affordable, the costs are still expensive and comparable to traditional recording industry standards for purchasing a copy of the content on a CD or DVD format (where you buy the DVD or CD with a copy of the content, but you don't actually own the content, for example if the DVD or CD is damaged or stolen, you don't get a free replacement for the copy you already purchased). iTunes provides for a user to download music, movies, audio books, and the like into a library that must be stored on the user's computer. iTunes does not retain the library for each user on its site; thus, if anything is lost or damaged or the computer is stolen, the library and the valuble content on it are no longer accessible by the user who rightfully owns that content, based on the licenses purchased.

Another website with content available through the Internet is youTube at www.youtube.com; it provides free content for play by any user on the site, and that free content is uploaded without review or confirmation of authorship or rights ownership, much less screened for quality or interest by users.

In both of the aforementioned cases, users can provide feedback or rating of the content. And the content may be categorized by subject or genre or artist. To some limited extent, it may also be searched through the website.

The Internet and web-based media distribution, along with the improvement of electronic devices for creating digital representations of works, has changed the entertainment scene; however, the industry—especially music, movies, and broadcast media (perhaps with the exception of XM radio)—has not significantly changed the business model for providing digital entertainment content to authorized users. The traditional industry position has held that its position is based on the protection of copyrights and other intellectual property; in fact, copyright infringement and illegal downloading have been problematic for a long, long time. The Internet alone has not addressed the problem of providing diverse, on-demand content to authorized users at reasonable rates, while providing reasonable compensation to artists and authors for participating in a structured, managed format. Thus there remains a need for a system and methods that provide for digital content creation and upload through a managed website for providing network-based access to authorized users who pay for predetermined rights that allow for use of the content by the authorized user on a multiplicity of devices, without having to repurchase access to the same content.

### SUMMARY OF THE INVENTION

A first aspect of the present invention is to provide a method for providing automatic electronic alerts relating to promoting digital media for distribution to users over a network including the steps of: providing a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage site(s) and available for selective download by authorized users of the network who access website remotely and who are associated with an active account through the website; wherein the DRF is provided by a creating user having rights to the DRF; and wherein the DRM downloads are provided to authorized users based upon a predetermined number of simultaneous playback units of each DRM unit; and providing geographic alerts to authorized users including promotional material for the DRM that is automatically associated with the DRM available for access at the website, thereby providing an automated promotion and distribution system for digital media through the network.

A second aspect of the present invention is to provide method for promoting digital media for distribution to users over a network using personalized notification to users including the steps of: providing a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage server(s) and available for selective access by authorized users of the network who access website remotely and who are associated with an active account through the website; wherein the DRF is provided by a creating user having rights to the DRF; and wherein the DRM access is provided to authorized users based upon authorized user selection of content via a content index associated with an authorized user in an interactive graphic user interface (GUI); and providing personalized notification to authorized users, the personalized notification including promotional support for the DRM that is automatically associated with the DRM available for access at the website, and geography-specific information about activities related to each user's content index, wherein the information is provided to the authorized users based upon their geographic location indication, thereby providing an automated promotion and distribution system for digital media through the network.

Another aspect of the present invention is to provide a method for providing automated alerts in connection with promoting digital media for distribution to users over a network including the steps of: providing a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage site(s) and available for selective download by authorized users of the network who access website remotely and who are associated with an active account through the website; wherein the DRF is provided by a creating user having rights to the DRF; and wherein the DRM downloads are provided to authorized users based upon a predetermined number of simultaneous playback units of each DRM unit; and providing automatic alerts directly to the authorized user(s) including promotional support for the DRM that is automatically associated with the DRM available for access at the website, thereby providing an automated promotion and distribution system for digital media through the network.

Thus, the present invention provides automated alerts or notification to authorized users for promotion of the DRM that is maintained remotely through the website through which the user accesses the DRM content.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a flow diagram of the method according to one embodiment of the present invention.

FIG. 2 is a schematic diagram of the system supporting the methods of use, in accordance with an embodiment of the present invention.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides a system and methods that provide for a method for providing automatic electronic alerts relating to promoting digital media for distribution to users over a network including the steps of: providing a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage site(s) and available for selective download by authorized users of the network who access website remotely and who are associated with an active account through the website; wherein the DRF is provided by a creating user having rights to the DRF; and wherein the DRM downloads are provided to authorized users based upon a predetermined number of simultaneous playback units of each DRM unit; and providing geographic alerts to authorized users including promotional material for the DRM that is automatically associated with the DRM available for access at the website, thereby providing an automated promotion and distribution system for digital media through the network.

In another embodiment of the present invention provides a method for promoting digital media for distribution to users over a network using personalized notification to users including the steps of: providing a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage server(s) and available for selective access by authorized users of the network who access website remotely and who are associated with an active account through the website; wherein the DRF is provided by a creating user having rights to the DRF; and wherein the DRM access is provided to authorized users based upon authorized user selection of content via a content index associated with an authorized user in an interactive graphic user interface (GUI); and providing personalized notification to authorized users, the personalized notification including promotional support for the DRM that is automatically associated with the DRM available for access at the website, and geography-specific information about activities related to each user's content index, wherein the information is provided to the authorized users based upon their geographic location indication, thereby providing an automated promotion and distribution system for digital media through the network.

Also, the present invention provides a method for providing automated alerts in connection with promoting digital media for distribution to users over a network including the steps of: providing a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage site(s) and available for selective download by authorized users of the network who access website remotely and who are associated with an active account through the website; wherein the DRF is provided by a creating user having rights to the DRF; and wherein the DRM downloads are provided to authorized users based upon a predetermined number of simultaneous playback units of each DRM unit; and providing automatic alerts directly to the authorized user(s) including promotional support for the DRM that is automatically associated with the DRM available for access at the website, thereby providing an automated promotion and distribution system for digital media through the network.

The alerts are preferably automatic and provided by the same website that is managing the digital content creation, upload, distribution and promotion through network-based access to authorized users who pay for predetermined rights that allow for use of the content by the authorized user. In one embodiment, the authorized user has a user account and profile that provides for simultaneous use of the content on a multiplicity of devices, without having to repurchase access to the same content to address the longstanding, unmet needs within the entertainment industry to address interests of consumers, artists and authors, and the entity managing and securing authorized, legal rights to distribute and sell access to that digital content, on demand by authorized users. This multiple-device distribution arrangement provides for unique promotional opportunities to the user, based upon content use and profile, including promotion that relates to specific devices. Advantageously, the alerts or notification system to authorized users leverages the multiple- and/or mobile device access and content distribution; since the devices communicate with the website and also have a geographic indicator of location at the time of access, the system can personalize notification to the authorized user automatically according to device geography. In one case, the user registers devices through the website with the authorized user account and/or profile; this profile can be updated by the user. Only devices registered to the user can access the content via the user's account and content index that is specific to that user. Those registered devices are preferably operable to interactively communicate with the site to transmit information on geographic location and then receive geographic-specific information that is also preferably customized to the user preferences based upon the user profile, account, and/or content index (and combinations thereof).

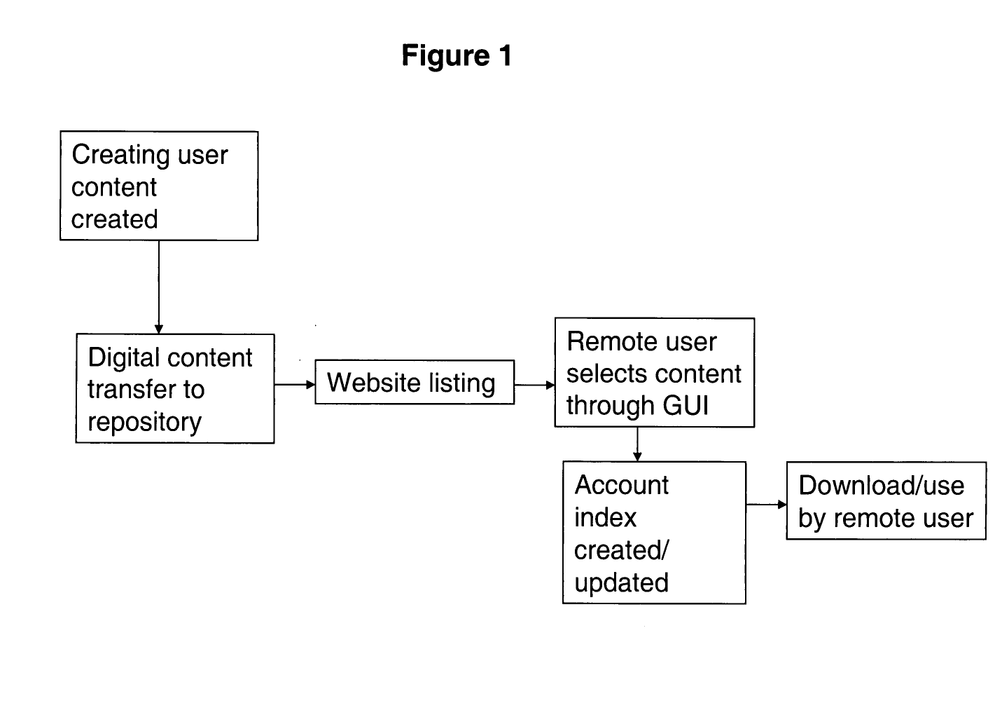

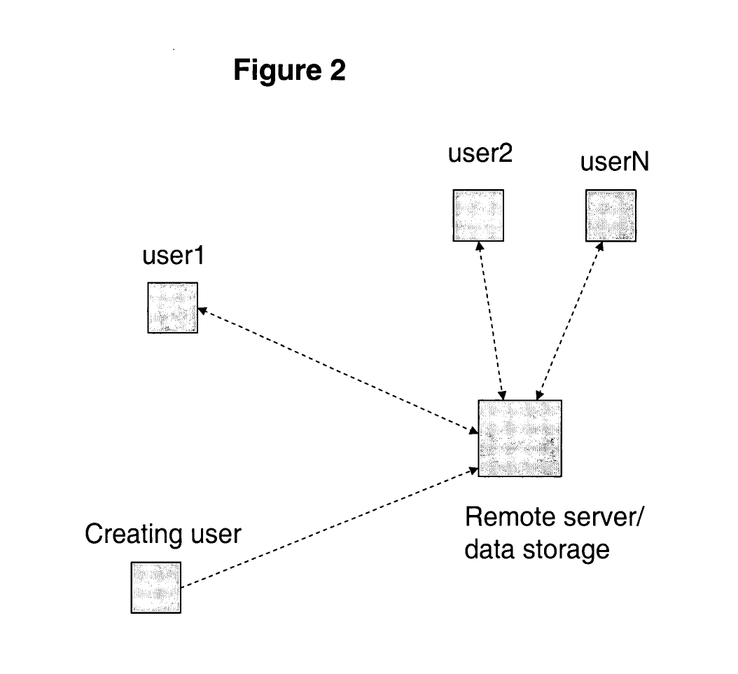

Referring now to the drawings in general, the illustrations are for the purpose of describing the basic content creation, upload, and distribution aspects of the invention and are not intended to limit the invention thereto. As best seen in FIG. 1, a flow diagram is provided for user access to the system, which is shown in the schematic representation of FIG. 2. FIG. 1 illustrates steps for a creating user to create content, transfer the digital version of the content to a data input or repository for storage, indexing, and access, the website generating a listing or index associated with that content, including categorization, a user selecting content and an automatic generation of an account content index, and then the user using the content, such as via download of a digital copy of the content. FIG. 2 illustrates user1, user2, . . . userN interacting with a remote server or data repository through network interaction; also, a creating user accessing the remote server or data repository for uploading digital content is illustrated. The geographic location and personalized information or alerts are communicated between the user/device(s) and the remote server via the network as illustrated.

The present invention provides a method for providing digital media for distribution to users over a network, and providing promotion for that digital media to the users, including the steps of providing a digital representation of media (DRM) available for distribution over a network, wherein the DRM is provided in a digitally recorded format (DRF) and transmittable remotely to a network portal for upload to a website; and providing the DRM in DRM unit(s) stored remotely at a data storage site(s) and available for selective download by authorized users of the network who access website (through the network portal) remotely and who are associated with an active account through the website; wherein the DRF is provided by a creator of the DRF; the creating user agreeing to or providing promotional materials for the DRM, preferably also in a DRF format; and wherein the DRM downloads are provided to authorized users based upon a predetermined number of simultaneous playback units of each DRM unit. In one embodiment, preferably, the DRM downloads are repeatedly downloadable based upon a predetermined number of downloads per DRM unit, which is associated with each authorized user, not based upon the number of devices to which the DRM is downloaded. Importantly, in sharp contrast to prior art, the DRM download does not affect the DRM availability to the authorized user, because according to the present invention, the DRM or the actual content is stored remotely from the authorized user and therefore the content remains with the website, and is actually not transferred to the user. A digital copy is downloaded by the user onto any device owned or operated by the user, in exchange for a license to use or play the DRM in accordance with the license rights granted.

Significantly, with the methods and the system of the present invention, in one embodiment the user has completely remote access to DRM that is maintained by someone other than the authorized user. Also, the user has access to download and play the DRM units based upon actual simultaneous play of any DRM unit, regardless of the format or type of device on which the DRM units are played or accessed by the user. So then if the user is traveling anywhere on the globe but accessing the network from a multiplicity of access devices, including but not limited to mobile phones, computers, PDAs, MP3 players, audio and/or visual players, DVRs, and the like, and combinations thereof, then the user still has access to any DRM units within that user's authorized portfolio (or collection, family, group, database, depository, repository) of DRM units, which are available for selective download and play, or direct experience (including audio and/or video) through the website portal, accessed by the authorized user through a network such as the world wide web or Internet.

The user creates their own portfolio of content in DRM, including but not limited to music, movies, audio books, podcasts, radio, news, broadcasts (stored), and the like, and combinations thereof. The portfolio index of that content is stored for each user, while the content distributor or provider stores only one digital copy of each DRM, thereby creating a singular or primary library that is remotely stored from any user or user's device(s). The portfolio index indicates which of the primary library the user has rights to access simultaneously, regardless of the device on which the user wants to access or download the content. Users can therefore access the content from any device, at any time, any place that is network accessible. The predetermined number of DRM units accessible by a single authorized user for simultaneous use is established to be between one (1) and N, where N is provided to ensure flexibility of enjoyment and use by an authorized user, but N is less than unlimited in order to ensure that the system and methods of the present invention are used, and therefore to prevent counterfeiting, illegal access or downloading, which ensures appropriate compensation to the authors, artists, and distribution entity.

In the business model and methods of doing business for digital media content creation, upload, distribution, and promotion according to the present invention, including the automated alerts that are personalized to the user, including geography-specific alerts, the authorized users pay a fee for access to the content, and preferably, also pay a fee for predetermined promotional features, including the geography-based activities, such as performances, interviews, chats, and/or interactive sessions with the creating users or artists. Preferably, these alerts and promotions are provided in a customized manner to users based upon the user profile, account, and/or content index so that the alerts and promotions are attractive to the user. These additional activities, performances, or dynamic interactive sessions (live, in-person, or online) may be exclusive or private to the authorized users whose profile is related thereto; they may be optional, and may also be associated with a fee. Revenue sharing of this fee with the creating user may be the same or may be modified from the distribution arrangement based upon DRM units and other licensing. Other promotional features including alerts are provided on a non-fee basis, including but not limited to promotional offers based upon past purchases, promotional offers based upon the authorized user's content index, promotional offers based upon the authorized user's account and/or user profile or other data related to the user's interaction with the website. The user can opt in or opt out of promotional offers at any time, by indicating the user preference on the website. The DRM units and promotional features, including alerts, are either preselected, or selected by the authorized user based upon an alert or invitation, are documented in that authorized user's portfolio index, which references which portions of the primary library that authorized user has rights to access, and which promotional features the user has opted in or opted out of. In one embodiment, for each paid content unit, or DRM unit, and promotional features, the authorized user pays a predetermined amount that is significantly less than other web-based models.

The authorized user may also selectively indicate a geographic location in advance, such as before travel to another city, state, or country, or to the space station. Preferably, the authorized user can download for play for air travel and receive alerts on both departing and arriving ends of the trip.

A portfolio index may be optionally shared with other authorized users, preferably for a fee. By way of example to illustrate this case, and not by way of limitation of the scope of the invention, a family of four may elect to pay for 2, 3, or 4 concurrent users of the database allowing that number of users to access any combination of works simultaneously. So a family with a three-user license may be playing song A in a car, song A in the kitchen, and movie B in the den at the same time since they have paid for three people to access the database simultaneously. Furthermore, distinctions may be identified for different types of users allowing them to be charged using differing methods. For example, a movie theater may download or access a movie to be run for a number of people to view simultaneously; also, they may opt in or opt out of promotional material for other films (previews and advertisements). The artist/owner would then be paid a fee based on the number of people viewing the movie. Distinctions could be made for other types of users including schools, radio stations, dance clubs, etc where the fee could be nothing, based on number of viewers/listeners, or based on the capacity of the venue.

Preferably, the DRF for the content and promotional features including alerts are input directly by the creator, artist, agent, owner or authorized creative entity (hereinafter “creating user”) for distribution through the website. In one embodiment, the DRF is created by the creator or creating user at a media station having direct connectivity for upload to the website. In another embodiment, the creating user has a pre-digitally recorded copy of the content ready-to-distribute. The creating user, in any case, makes a certification that they are the true author or owner of the content they intend to provide for digital upload and distribution through the site. Additionally, the creating user has the sole decision as to what content is uploaded, including digital media content and promotional material content.

Optionally, there is a review panel that provides for screening of content, including promotional material, for rating and/or quality purposes. The review panel may include authorized users, and preferably active users who can provide a democratic voice or at least a representative cross-section of the users to indicate what position the user base may be. This may be further subdivided by geography, religion, language, etc.

Certain modifications and improvements will occur to those skilled in the art upon a reading of the foregoing description. By way of example, technological advancements in media may include a form other than “digital” media; a variety of methods may be created to “download” or “access” media; numerous hand held, microchip, contact lens, ear piece, or implanted devices may be utilized to view and hear media or send the information directly to the brain; other methods of sharing a database or indexing that database could be utilized, etc. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A method for providing automatic electronic alerts relating to promoting digital media for distribution to users over a network comprising the steps of:
providing a digital representation of media (DRM) available for distribution over a network, wherein the DRM is provided in a digitally recorded format (DRF) and transmittable remotely to a network portal for upload to a website;
providing the DRM in DRM unit(s) stored remotely at a data storage site(s) and available for selective download by authorized users of the network who access website remotely and who are associated with an active account through the website;
wherein the DRF is provided by a creating user having rights to the DRF; and
wherein the DRM downloads are provided to authorized users based upon a predetermined number of simultaneous playback units of each DRM unit; and
providing geographic alerts to authorized users including promotional material for the DRM that is automatically associated with the DRM available for access at the website, thereby providing an automated promotion and distribution system for digital media through the network.

2. The method of claim 1, wherein the geographic alerts are related to a content index associated with the DRM selected for use by the authorized user.

3. The method of claim 1, wherein the geographic alerts include geography-specific activities in which the authorized user may participate.

4. The method of claim 3, wherein the activities are selected from the group consisting of private or exclusive performances, showings or interactive sessions with the creating user(s) of select DRM content.

5. The method of claim 1, wherein the geographic alerts are provided to authorized user(s) based upon the geographic location of each of the authorized users.

6. The method of claim 5, wherein the authorized user geographic location is determined automatically based upon activity by a network-enabled device registered to the authorized user in communication with the system.

7. The method of claim 1, wherein the geographic alerts are associated with trends in the content index for each authorized user.

8. The method of claim 1, wherein the promotional support includes marketing collateral materials for web-based advertising or promotion of the DRM.

9. The method of claim 1, further including the step of updating the promotional support.

10. The method of claim 9, wherein the step of updating the promotional support is automated, and occurs at predetermined times, and is associated with geographic alerts correlating to select promotional support.

11. The method of claim 10, wherein the promotional support and geographic alerts includes interactive content.

12. The method of claim 11, wherein the interactive content includes options for dynamic interaction with the creating user.

13. The method of claim 1, wherein the promotional support and geographic alerts are created and provided in DRF by the creating user.

14. A method for promoting digital media for distribution to users over a network using personalized notification to users comprising the steps of:
providing a digital representation of media (DRM) available for distribution over a network, wherein the DRM is provided in a digitally recorded format (DRF) and transmittable remotely to a network portal for upload to a website;
providing the DRM in DRM unit(s) stored remotely at a data storage server(s) and available for selective access by authorized users of the network who access website remotely and who are associated with an active account through the website;
wherein the DRF is provided by a creating user having rights to the DRF; and
wherein the DRM access is provided to authorized users based upon authorized user selection of content via a content index associated with an authorized user in an interactive graphic user interface (GUI); and
providing personalized notification to authorized users, the personalized notification including promotional support for the DRM that is automatically associated with the DRM available for access at the website, and geography-specific information about activities related to each user's content index, wherein the information is provided to the authorized users based upon their geographic location indication,
thereby providing an automated promotion and distribution system for digital media through the network.

15. The method of claim 14, wherein the content index is modifiable by the authorized user and automatically updated based upon modifications by the user, and wherein the promotional support and personalized notification is automatically provided to the user based upon the content index content.

16. The method of claim 15, further including the step of automatically updating the promotional support and based upon authorized user access and updates provided by the user.

17. The method of claim 16, wherein the user updates include user geographic location that is automatically indicated to the website through network communication by a network enabled device registered to the authorized user.

18. A method for providing automated alerts in connection with promoting digital media for distribution to users over a network comprising the steps of:
providing a digital representation of media (DRM) available for distribution over a network, wherein the DRM is provided in a digitally recorded format (DRF) and transmittable remotely to a network portal for upload to a website;
providing the DRM in DRM unit(s) stored remotely at a data storage site(s) and available for selective download by authorized users of the network who access website remotely and who are associated with an active account through the website;
wherein the DRF is provided by a creating user having rights to the DRF; and
wherein the DRM downloads are provided to authorized users based upon a predetermined number of simultaneous playback units of each DRM unit; and
providing automatic alerts directly to the authorized user(s) including promotional support for the DRM that is automatically associated with the DRM available for access at the website,
thereby providing an automated promotion and distribution system for digital media through the network.

19. The method of claim 18, wherein the automatic alerts are provided on a geographically selective basis.

20. The method of claim 18, wherein the automatic alerts are provided directly to authorized user(s) based upon the geographic location or intended geographic location of each of the authorized users.

21. The method of claim 20, wherein the authorized user geographic location is determined automatically based upon activity by a network-enabled device registered to the authorized user.

22. The method of claim 18, wherein the automatic alerts are associated with the content index for each authorized user.
